(19) United States
(12) Patent Application Publication
(10) Pub. No.: US 2018/0170248 A1
(43) Pub. Date: Jun. 21, 2018

(54) Vehicle Warning Device

(71) Applicant: Doug Turnbull, Collingwood (CA)

(72) Inventor: Doug Turnbull, Collingwood (CA)

(21) Appl. No.: 15/386,772

(22) Filed: Dec. 21, 2016

(51) Int. Cl. B60Q 1/44; B60Q 1/26

(52) U.S. Cl. CPC B60Q 1/444; B60Q 2400/20; B60Q 1/2696

(57) ABSTRACT

A vehicle warning device for signaling trailing motorists includes a housing that defines an internal space. The housing is configured to mount to a vehicle such that a front face of the housing is visible from a rear side of the vehicle. A plurality of lights is coupled to the housing and is positioned on the front face. The lights are operationally couplable to a throttle, a brake system and an electrical circuit of the vehicle. The lights are configured to selectively illuminate to signal to trailing motorists a position of the throttle and a state of the brake system of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to warning devices and more particularly pertains to a new warning device for signaling trailing motorists.

### BRIEF SUMMARY OF THE INVENTION

An embodiment of the disclosure meets the needs presented above by generally comprising a housing that defines an internal space. The housing is configured to mount to a vehicle such that a front face of the housing is visible from a rear side of the vehicle. A plurality of lights is coupled to the housing and is positioned on the front face. The lights are operationally couplable to a throttle, a brake system and an electrical circuit of the vehicle. The lights are configured to selectively illuminate to signal to trailing motorists a position of the throttle and a state of the brake system of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle warning device according to an embodiment of the disclosure.

FIG. 2 is a top view of an embodiment of the disclosure.

FIG. 3 is a bottom view of an embodiment of the disclosure.

FIG. 4 is an in-use view of an embodiment of the disclosure.

### DETAILED DESCRIPTION OF THE INVENTION

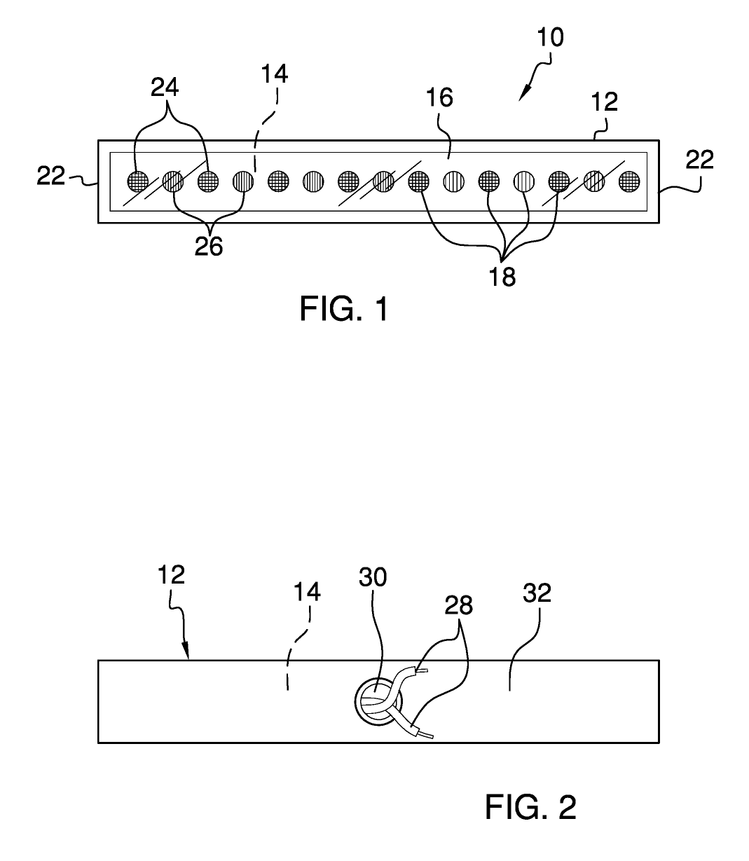

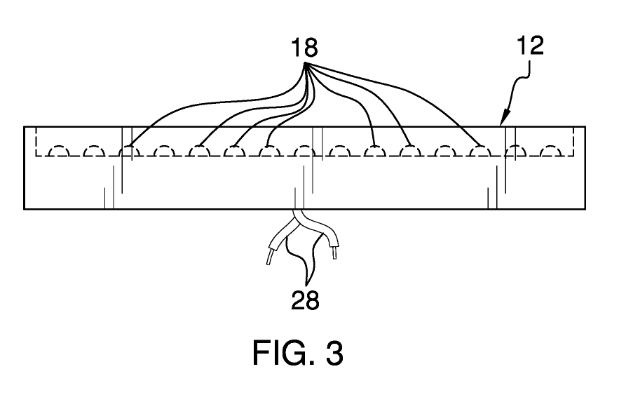

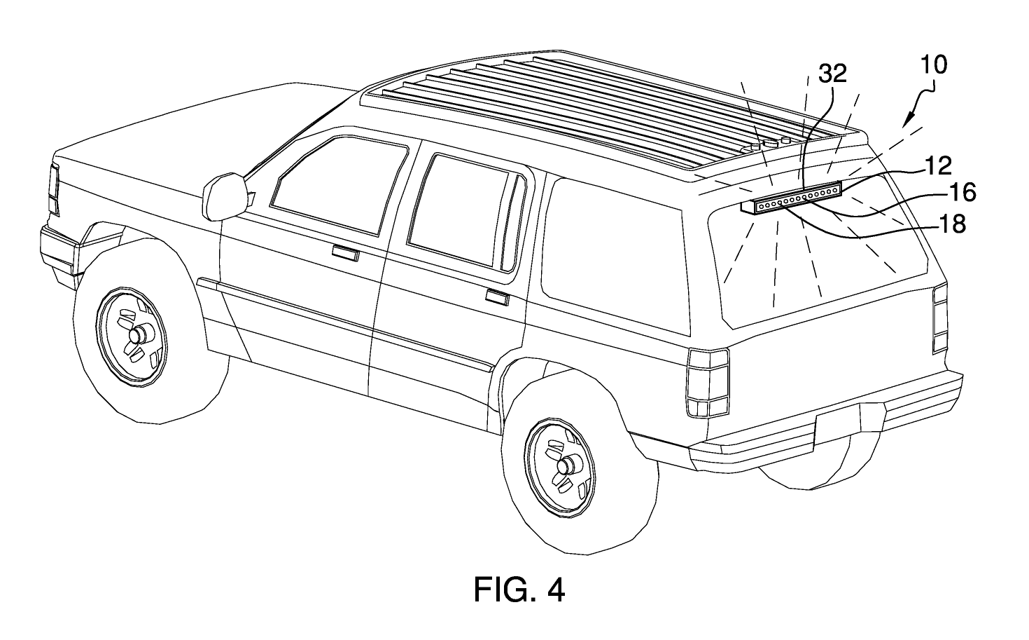

With reference now to the drawings, and in particular to FIGS. 1 through 4 thereof, a new warning device embodying the principles and concepts of an embodiment of the disclosure and generally designated by the reference numeral 10 will be described.

As best illustrated in FIGS. 1 through 4, the vehicle warning device 10 generally comprises a housing 12 that defines an internal space 14. The housing 12 is configured to mount to a vehicle such that a front face 16 of the housing 12 is visible from a rear side of the vehicle. In one embodiment, the housing 12 is substantially rectangularly box shaped.

A plurality of lights 18 is coupled to the housing 12 and is positioned on the front face 16. The plurality of lights 18 is operationally couplable to a throttle, a brake system and an electrical circuit of the vehicle. The plurality of lights 18 is configured to selectively illuminate to signal to trailing motorists a position of the throttle and a state of the brake system of the vehicle. In one embodiment, the plurality of lights 18 comprises light emitting diodes 20. In another embodiment, the plurality of lights 18 is positioned linearly. In yet another embodiment, the plurality of lights 18 extends between opposing sides 22 of the housing 12.

In one embodiment, the plurality of lights 18 comprises yellow lights 24 and red lights 26. The yellow lights 24 are configured to illuminate to signal to trailing motorists that the throttle of the vehicle is in a disengaged position and that the vehicle is subject to deceleration. The red lights 26 are configured to illuminate to signal to trailing motorists that the brake system of the vehicle is in an engaged state and that the vehicle is decelerating. In another embodiment, the yellow lights 24 and the red lights 26 are alternately positioned on the front face 16 of the housing 12.

A plurality of wires 28 is coupled to the plurality of lights 18 and is positioned in the internal space 14. The wires 28 extend from the housing 12. The wires 28 are operationally coupled to the plurality of lights 18. The wires 28 are operationally couplable to the throttle, the brake system and the electrical circuit of the vehicle.

A penetration 30 is positioned in a top face 32 of the housing 12. The penetration 30 is positioned to extend the wires 28 through the penetration 30. In one embodiment, the penetration 30 is circularly shaped. In another embodiment, the penetration 30 is centrally positioned through the top face 32 of the housing 12.

In use, the housing 12 is configured to mount to the vehicle such that the front face 16 of the housing 12 is visible from the rear side of the vehicle. The yellow lights 24 are configured to illuminate to signal to trailing motorists that the throttle of the vehicle is in the disengaged position and that the vehicle is subject to deceleration. The red lights 26 are configured to illuminate to signal to trailing motorists that the brake system of the vehicle is in the engaged state and that the vehicle is decelerating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle warning device comprising:
a housing defining an internal space, said housing being configured for mounting to a vehicle such that a front face of said housing is visible from a rear side of the vehicle;
a plurality of lights coupled to said housing and positioned on said front face, said lights being operationally couplable to a throttle, a brake system and an electrical circuit of the vehicle, said plurality of lights comprising light emitting diodes, said plurality of lights being positioned linearly extending in a single line between opposing sides of said housing, said plurality of lights comprising yellow lights and red lights, wherein said yellow lights are positioned on said housing such that said yellow lights are configured for illuminating to signal to trailing motorists that the throttle of the vehicle is in a disengaged position, such that the vehicle is subject to deceleration, and wherein said red lights are positioned on said housing such that said red lights are configured for illuminating to signal to trailing motorists that the brake system of the vehicle is in an engaged state and that the vehicle is decelerating, said yellow lights and said red lights being alternately positioned on said front face of said housing, each of said yellow lights being positioned between an associated pair of said red lights wherein said single line comprises red lights as each end of said single line; and
wherein said plurality of lights is positioned on said housing such that said plurality of lights is configured for selectively illuminating to signal to trailing motorists a position of the throttle and a state of the brake system of the vehicle.

2. The device of claim 1, further including said housing being substantially rectangularly box shaped.

3. (canceled)

4. (canceled)

5. (canceled)

6. (canceled)

7. (canceled)

8. The device of claim 1, further including a plurality of wires coupled to said plurality of lights and positioned in said internal space, said wires extending from said housing, said wires being operationally coupled to said plurality of lights, said wires being operationally couplable to the throttle, the brake system and the electrical circuit of the vehicle.

9. The device of claim 8, further including a penetration positioned in a top face of said housing, wherein said penetration is positioned in said housing such that said penetration is positioned for extension of said wires through said penetration.

10. The device of claim 9, further including said penetration being circularly shaped.

11. The device of claim 9, further including said penetration being centrally positioned through said top face of said housing.

12. A vehicle warning device comprising:
a housing defining an internal space, said housing being configured for mounting to a vehicle such that a front face of said housing is visible from a rear side of the vehicle, said housing being substantially rectangularly box shaped;
a plurality of lights coupled to said housing and positioned on said front face, said plurality of lights being operationally couplable to a throttle, a brake system and an electrical circuit of the vehicle, wherein said plurality of lights is positioned on said housing such that said plurality of lights is configured for selectively illuminating to signal to trailing motorists a position of the throttle and a state of the brake system of the vehicle, said plurality of lights comprising light emitting diodes, said plurality of lights being positioned linearly in a single line extending between opposing sides of said housing, said plurality of lights comprising yellow lights and red lights, wherein said yellow lights are positioned on said housing such that said yellow lights are configured for illuminating to signal to trailing motorists that the throttle of the vehicle is in a disengaged position, such that the vehicle is subject to deceleration, and wherein said red lights are positioned on said housing such that said red lights are configured for illuminating to signal to trailing motorists that the brake system of the vehicle is in an engaged state and that the vehicle is decelerating, said yellow lights and said red lights being alternately positioned on said front face of said housing, each of said yellow lights being positioned between an associated pair of said red lights wherein said single line comprises red lights as each end of said single line;
a plurality of wires coupled to said plurality of lights and positioned in said internal space, said wires extending from said housing, said wires being operationally coupled to said plurality of lights, said wires being operationally couplable to the throttle, the brake system and the electrical circuit of the vehicle; and
a penetration positioned in a top face of said housing, wherein said penetration is positioned in said housing such that said penetration is positioned for extension of said wires through said penetration, said penetration being circularly shaped, said penetration being centrally positioned through said top face of said housing.
